(19) United States
(12) Patent Application Publication
(10) Pub. No.: US 2010/0241473 A1
(43) Pub. Date: Sep. 23, 2010

(54) METHOD OF MANAGING LIGHT ENERGY AND SYSTEM OF THE SAME

(75) Inventor: Hsueh Cheng Huang, Hamilton (NZ)

Correspondence Address: EDWARDS ANGELL PALMER & DODGE LLP, P.O. BOX 55874, BOSTON, MA, 02205, US

(73) Assignee: OPEN MINDER GROUP LIMITED, Tortola (VG)

(21) Appl. No.: 12/725,944

(22) Filed: Mar. 17, 2010

(30) Foreign Application Priority Data
Mar. 17, 2009 (TW) 098108544

(51) Int. Cl. G06Q 50/00; G06Q 10/00; G06N 5/02; G06F 1/26; G06F 1/28; G05D 23/19; G01B 11/14

(52) U.S. Cl. 705/7; 706/47; 700/297; 356/614; 700/286; 700/300

(57) ABSTRACT

A system and method of managing light energy are provided. A detecting apparatus detects input information related to input light energy and environmental information related to efficiency of inputting light energy. Then, an analysis and management apparatus calculates, analyzes, classifies, manages or optimizes the input information and environmental information by predetermined parameters or rules, and determines whether to take a corresponding action according to results of analysis or management. Accordingly, drawbacks of prior arts, that the source of light energy cannot be handled accurately and difficulties in controlling and optimizing light energy persist, can be solved.

### BACKGROUND OF THE INVENTION

1. Field of the Invention

The present invention relates to a system and method of managing light energy, and more particularly, to a system and method for analyzing and managing various information related to the light energy.

2. Description of Related Art

The energy crisis is a critical issue to worldwide experts and scholars. Nowadays, it is important for human beings to develop alternative energy sources. Light energy is a form of energy. The prerequisite for utilization of light energy as a kind of alternative energy lies in a good understanding of characteristics of light energy and ensuing control and management of the input light energy.

Before light energy can be controlled and managed, its source, directions, positions and intensity should be identified effectively. Nevertheless, now there are neither technologies for identifying the correlation between characteristics of light energy and environment in real time, nor application modes for completely putting the light energy utilization into practice.

Take the photovoltaic solar energy industry for example. Most of the existing photovoltaic technologies are to convert solar energy into electricity and utilization of the converted energy. In order to collect solar energy, the operation mode is configured to choose an area and to install a number of photovoltaic array or solar energy collecting devices in that area. However, conventional methods for installation of the solar energy collecting devices are short of optimization, because the conventional methods are so inflexible that the quantity of input solar energy within that sunshine area cannot be measured accurately. Current solar energy been converted from photovoltaic or solar energy collecting devices can only be coarsely estimated according to an ecliptic diagram, environmental parameters, or the size and area of the installed solar energy collecting devices. With limited information, it is difficult to utilize solar energy effectively and efficiently. Given a good understanding of the characteristics of light energy, it is feasible to optimize installation of solar energy collecting devices, and thus the operations of other solar energy devices in the form of matrix, along with the adjustment and control of solar energy, can be enhanced.

Consequently, an unsolved issue involves developing a system and method of managing light energy to detect information related to light energy and do analysis and management thereof based on the detected information, in order to get better understanding of the characteristics of light energy.

### SUMMARY OF THE INVENTION

In order to overcome the drawbacks of prior arts, the present invention provides a method of managing light energy, comprising the steps of: (1) detecting input information related to coordinate positions, input light energy, and environmental information related to efficiency of inputting light energy by a detecting apparatus; and (2) analyzing or managing the input information via the use of predetermined parameters or rules by an analysis and management apparatus so as to determine whether to take a corresponding action according to results of analysis or management in the form of matrix/scale.

In a preferred embodiment of the present invention, the aforementioned method can be applied to solar energy industry, wherein Step (1) further comprises: (1-1) guiding the solar energy by an energy guiding device; and (1-2) converting the solar energy by a conversion device so as to produce energy or utilize the energy thus produced; wherein step (2) further comprises: analyzing and managing the input information related to the coordinate positions, the solar energy, and the environmental information by predetermined parameters or rules so as to adjust, maintain or control the energy produced by the conversion device in accordance with the results of analysis or management.

The present invention further provides a system of managing light energy, including: a detecting module for detecting input information related to the light energy and environmental information related to input efficiency of the light energy in real time or at preset time intervals; and an analysis and management module for analyzing or managing the input information and environmental information via the use of predetermined parameters or rules so as to determine whether to take a corresponding action according to results of analysis or management.

In a preferred embodiment, the aforementioned system can be applied in the solar energy industry, wherein the system includes: an energy guiding module for guiding solar energy; a conversion module for converting the guided solar energy to produce energy, wherein the analysis and management module analyzes and manages information related to input solar energy and the environmental data related to efficiency of inputting solar energy by predetermined parameters or rules, and adjusting, maintaining or controlling energy produced by the conversion device in accordance with results of analysis or management.

When compared with prior arts, the system and method of managing light energy of the present invention have the advantages of: obtaining any information that may affect input efficiency of light energy through detecting the status of input light energy, and then utilizing the acquired information to determine whether to take a corresponding action, so as to master every characteristic and areas of light energy. The system and method of managing light energy of the present invention is useful to solar energy-related industries.

### BRIEF DESCRIPTION OF DRAWINGS

FIG. 1 is a flow diagram of the method of managing light energy according to the present invention;

FIG. 2 is a flow diagram showing an embodiment of detecting light according to the present invention;

FIG. 3 is a flow diagram showing an embodiment applied to the solar energy industry according to the present invention;

FIG. 4 shows the architecture of the system of managing light energy according to the present invention;

FIG. 5 is a schematic diagram of the system of managing light energy according to the present invention, wherein the system is implemented with computer software; and

FIG. 6 shows the architecture of the system of managing light energy, which is applied for energy conversion according to one embodiment of the present invention.

### DETAILED DESCRIPTION OF PREFERRED EMBODIMENTS

Specific embodiments are herein described in detail to explain the present invention, and numerous advantages and effects will become readily apparent to those skilled in the art once the disclosure is fully appreciated. It should be noted that the present invention may be implemented with various embodiments.

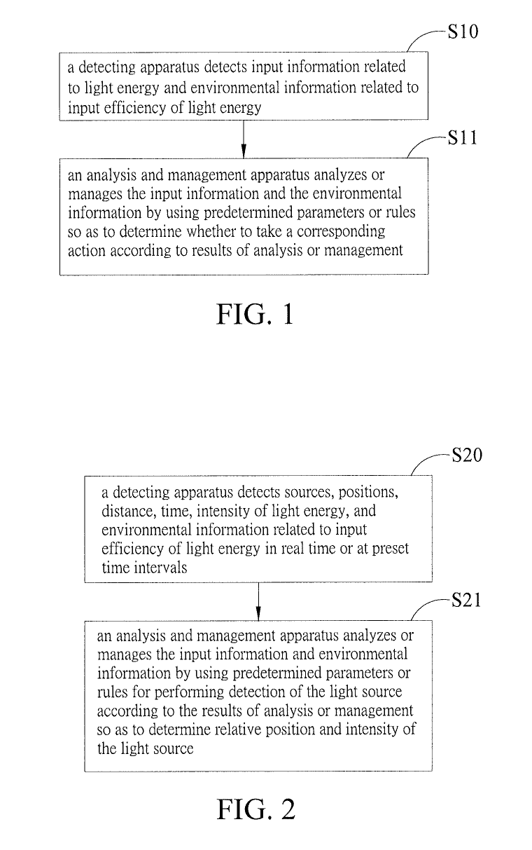

FIG. 1 is a flow diagram of the method of managing light energy according to the present invention. As shown in FIG. 1, the method comprises the following steps.

In Step S10, a detecting apparatus detects input information related to coordinate positions, input light energy and environmental information related to efficiency of inputting light energy in real time or at preset time intervals. The information related to input light energy include sources, positions, distance, time, intensity and environmental parameters regarding the input light energy, and the environmental information related to efficiency of inputting light energy is sunlight incident angle, distribution of sunlight, weather conditions, air quality, corresponding time, operational status of the energy guiding device, refractive index, or light transmittance. The aforementioned light energy is a form of energy that can be transmitted and utilized in the form of light.

In Step S11, an analysis and management apparatus analyzes and manages the input information by predetermined parameters or rules in real time or at preset time intervals, and determines whether to take a corresponding action according to results of analysis or management.

In a preferred embodiment, the analysis and management apparatus outputs information related to evaluation of industrial value, information related to profit and loss of business, and/or information related to optimized utilization of light energy after analyzing results of analysis or management. As a result, investors and/or information user can understand the status of their investment environment by reference to information related to evaluation of industrial value, while the energy companies can plan their strategies for light energy industry through the information related to business profit and loss and/or the optimized utilization.

FIG. 2 is a flow diagram showing an embodiment of detecting light according to the present invention. As shown in FIG. 2, it involves the following steps.

In Step S20, a detecting apparatus detects sources, positions, distance, and intensity regarding input light energy and environmental information related to efficiency of inputting light energy in real time or at preset time intervals.

In Step S21, an analysis and management apparatus analyzes or manages the input information and environmental information by predetermined parameters or rules, and detects light according to results of analysis or management, so as to determine relative positions of light-emitting devices and intensity of the light emitted therefrom.

In embodiments, the method of the present invention can be used in detecting the positions of luminaries. For example, when performing a search or detection in a dim environment, the present invention can detect light emitted by target devices and exactly determine the intensity and characteristics of the light emitted by the target devices and relative positions of the target devices.

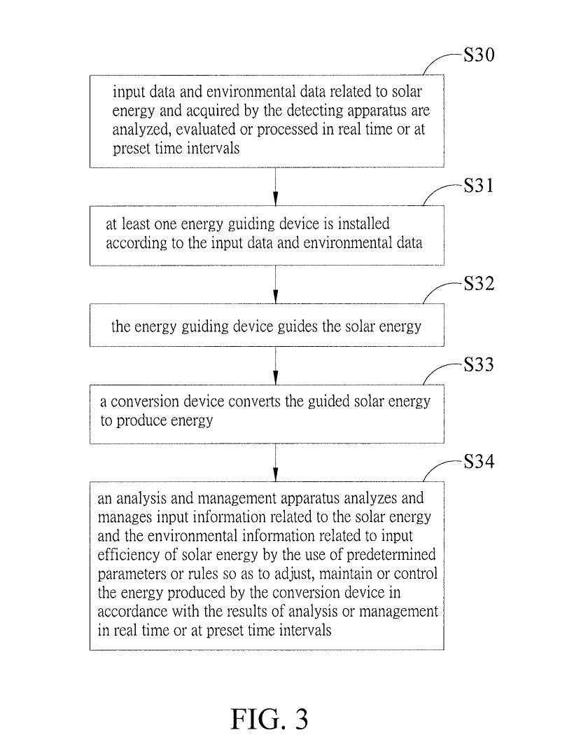

The present invention may further be applied to solar energy industry. FIG. 3 is a flow diagram showing an embodiment applied to the solar energy industry according to the present invention. It involves the following steps.

In Step S30, input-related data and environmental data related to solar energy and acquired by the detecting apparatus are analyzed, evaluated and processed.

In Step S31, at least an energy guiding device is installed according to the input-related data and environmental data acquired in real time or at preset time intervals. The energy guiding device is capable of guiding-in, guiding-out, refracting, reflecting, intensifying, dispersing, and collecting light. For example, the energy guiding device could be any kinds of parabolic mirrors, reflective mirrors, and CSP (concentrated solar power).

The above steps are also known as field work. In embodiments, the field work is performed in real time or at preset time intervals, so as to obtain various environmental data related to solar energy, like distribution of solar energy, weather and terrain status. The data are further analyzed and evaluated in order to determine the positions where the energy guiding devices are to be installed. For instance, when solar energy companies plan to build multiple sets of energy guiding devices in a certain area, the field work of the present invention can be utilized to obtain environmental data. By making reference to the environmental data, installation of solar energy guiding devices can be optimized, and the energy guided by the solar energy guiding devices can be accurately understood.

In Step S32, the energy guiding device guides solar energy.

In Step S33, a conversion device converting the guided solar energy so that the converted energy is produced and utilized. In embodiments, the energy guiding device guides solar energy. Then, a solar energy conversion device converts the guided solar energy and produces energy of many kinds so the converted energy can be further utilized. The energy produced by the conversion device includes electrical energy, thermal energy, and energy of other forms. For example, the conversion device may be a temperature-controlling boiler/furnace/kiln or photovoltaic panel or optical and/or utilization device, and the temperature-controlling boiler/furnace/kiln can convert received solar energy into thermal energy to manage and control the temperature of the boiler/furnace/kiln. In order to upgrade the temperature-controlling boiler/furnace/kiln to an industrial-graded boiler/furnace/kiln, another form of energy is used to increase the temperature of the temperature-controlling boiler/furnace/kiln to a predetermined value when the energy converted from the solar energy is not sufficient to heat the temperature-controlling boiler/furnace/kiln to reach the predetermined temperature. For example, the directions and angles of the energy guiding device is controlled or adjusted to guide in more solar energy, so as to increase the temperature of the temperature-controlling boiler/furnace/kiln to the predetermined value. In case the solar energy is inadequate, another accompanied energy device can supply thermal energy, plasma and/or induction heat source so as to maintain the operating temperature of the temperature-controlling boiler/furnace/kiln. Other accompanied energy devices may include electric heater coils, plasma, gas torches, and thermal power gas pipes, to provide coal direct burning, fuel thermal power, waste heat recycling, geotherm, and other kinds of thermal energy.

If the energy converted from the solar energy renders the temperature of the temperature-controlling boiler/furnace/kiln higher than the predetermined value, the temperature of the temperature-controlling boiler/furnace/kiln is decreased to below the predetermined value by reducing temperature of the energy guiding device or abating efficiency of the energy guiding device in guiding-in solar energy. Alternatively, the extra energy can be transmitted to other boiler/furnace/kilns or energy conversion devices. For example, the temperature can be lowered by gas cooling via a gas flow; increasing the contact surface area between a thermoelectric material and the temperature-controlling boiler/furnace/kiln to convert heat power into electric power; increasing volume of process materials by adding more materials; or increasing the open surface area of the temperature-controlling boiler/furnace/kiln to quickly lower its temperature.

In Step S34, an analysis and management apparatus analyzing or managing the information related to input solar energy and the environmental data related to efficiency of inputting solar energy according to the predetermined parameters or rules, and adjusting, maintaining or controlling energy produced by the conversion device in accordance with results of analysis and management.

In a preferred embodiment, an analysis and management apparatus of the present invention analyzes data acquired in real time or at preset time intervals, so as to determine what action to take. For example, the detecting apparatus acquires information related to the variations of the sunlight incident angle in real time or at preset time intervals, and then the analysis and management apparatus determines the action to take according to the acquired information. In a preferred embodiment, a solar energy guiding device maintains a constant quantity of energy to be guided and supplied to an environment required for the operation of boiler/furnace/kilns. The solar energy guiding device is adjustable to the sunlight incident angle in order to track the sun, so that it can adjust and control the quantity of received sunlight. A conversion device may also maintain a constant quantity of energy to be produced, or turn on/off the solar energy guiding device to facilitate real-time, precise adjustment.

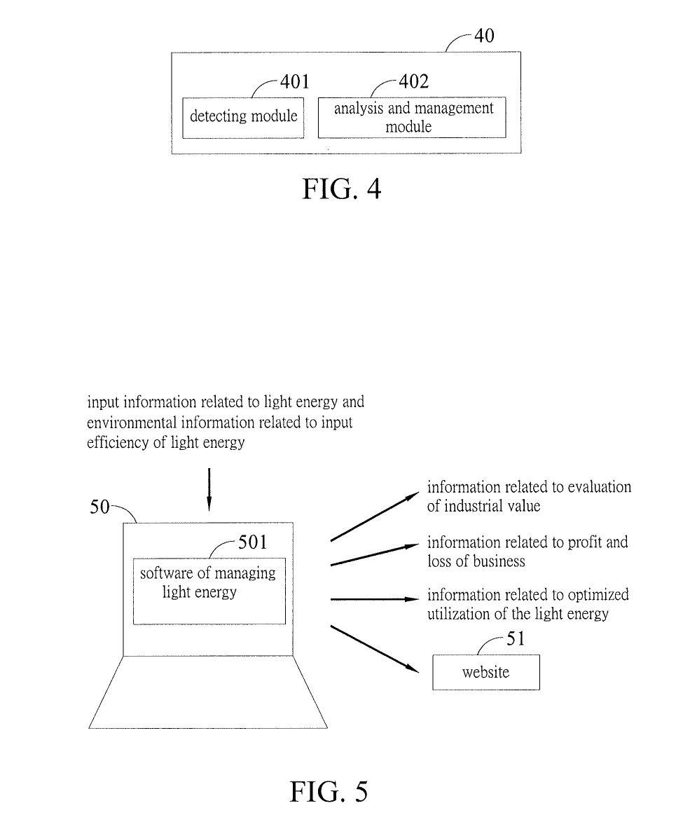

FIG. 4 shows the architecture of the system 40 of managing light energy according to the present invention. Its components are described in detail below.

The detecting module 401 detects input information related to input light energy and environmental information related to efficiency of inputting light energy in real time or at preset time intervals. The analysis and management module 402 analyzes and manages the input information and environmental information by predetermined parameters or rules, and determines whether to take a corresponding action according to results of analysis or management. Hence the system of the present invention can accurately handle sources of light energy and thereby control and optimize the light energy.

In a preferred embodiment, the analysis and management module further evaluates profit and loss of business of the related light energy industry by the predetermined real or simulated parameters.

FIG. 5 is a schematic diagram of the system of managing light energy according to the present invention, wherein the system is implemented with computer software. The software 501 of managing light energy, which is an embodiment of the system in FIG. 4, is installed on a computer 50. The software 501 is stored on various storage media, like memory, hard drives, network or optical disks.

In a preferred embodiment, the computer 50 receives from ambience or from an external device the information related to input light energy and environmental information related to efficiency of inputting light energy. The software 501 of managing light energy calculates and analyzes the information and determines whether a corresponding action is to be taken according to results of analysis. For example, the computer 50 outputs data related to evaluation of industrial value, data related to profit and loss of business, and/or data related to optimized utilization of the light energy. Investors can better understand terrain status and production capacity of a specific light energy industry, so that they can estimate the risk in advance. Another example is that the computer 50 can upload analytical data about various characteristics of light energy to a website 51 for public queries.

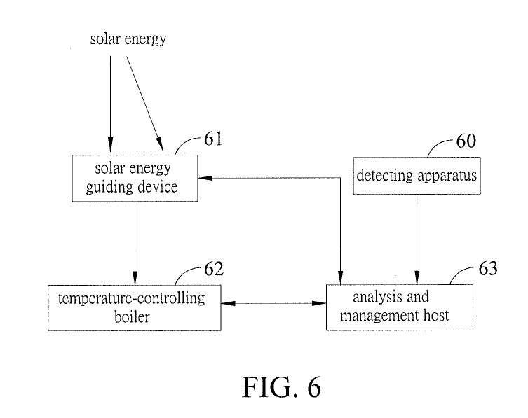

FIG. 6 shows the architecture of the system of managing light energy applied for energy conversion according to one embodiment of the present invention.

The solar energy guiding device 61 is configured to guide solar energy. For example, the energy guiding device could be any kinds of parabolic mirrors, reflective mirrors, and CSP (concentrated solar power). The temperature-controlling boiler/furnace/kiln 62 is configured to convert the solar energy guided by the solar energy guiding device 61 in order to produce energy. It should be noted that there is no limit for the types of the conversion device in the present invention. The energy produced by the conversion device may include electrical energy, thermal energy, and energy of other forms. The detecting apparatus 60 detects and acquires information related to input solar energy and environmental information related to efficiency of inputting solar energy, like sunlight incident angle, weather conditions, air quality, index of light refraction and light transmittance. The analysis and management host 63 determines whether to take a corresponding action according to the information acquired by the detecting apparatus 60, in order to adjust, maintain or control energy produced by the temperature-controlling boiler/furnace/kiln 62. For example, the analysis and management host 63 instructs, according to the information acquired by the detecting apparatus 60, the solar energy guiding device 61 to turn on, partially turn on, turn off, and partially turn off, so that the energy produced by the temperature-controlling boiler/furnace/kiln 62 is adjusted, maintained or controlled.

In a preferred embodiment, the system of managing light energy according to the present invention further includes a database for storing any data related to solar energy and acquired by the system.

In another preferred embodiment, the solar energy guiding device 61 is adjustable to the sunlight incident angle so as to track the sun, thereby adjusting and controlling the quantity of sunlight received by the solar energy guiding device 61.

In another preferred embodiment, when the energy converted from the solar energy is not sufficient to heat the temperature-controlling boiler/furnace/kiln 62 to the predetermined temperature, the directions and angles of the energy guiding device 61 is controlled or adjusted by the analysis and management host 63 in real time or at preset time intervals, in order to guide-in more solar energy to increase the temperature of the temperature-controlling boiler/furnace/kiln to the predetermined value.

If the energy converted from the solar energy renders the temperature of the temperature-controlling boiler/furnace/kiln 62 higher than the predetermined value, the temperature or efficiency of the solar energy guiding device 61 will be lowered by the analysis and management host 63, so that the temperature of the temperature-controlling boiler/furnace/kiln 62 is lowered to below the predetermined value.

In conclusion, the system and method of managing light energy according to the present invention have the following advantages:

(1) The information related to input light energy is detected and then further analyzed and managed so that every characteristic of the input light energy can be mastered;
(2) The analysis and management is conducted according to every mastered characteristic of light energy, in order to determine whether to perform a corresponding act or take a corresponding action, which are beneficial installation and use of solar energy equipment in the solar energy industry.

The foregoing descriptions of the detailed embodiments are only illustrated to disclose the principles and functions of the present invention, but not restrictive of the scope of the present invention. It should be understood to those skilled in the art that all modifications and variations according to the spirit and principle of the present invention can be made to the aforementioned embodiments.

1. A method of managing light energy, comprising the steps of:
(1) detecting input information related to coordinate positions and input light energy, and environmental information related to efficiency of inputting light energy by a detecting apparatus; and
(2) analyzing or managing the input information via the use of predetermined parameters or rules by an analysis and management apparatus so as to determine whether to take a corresponding action according to results of analysis or management in the form of matrix/scale.

2. The method of claim 1, wherein the light energy is a form of energy transmitted or utilized in form of light, and the input information related to the input light energy include sources, positions, distance, time, intensity, and environmental parameters of the input light energy.

3. The method of claim 1, wherein the light energy is solar energy.

4. The method of claim 1, wherein in step (2) the analysis and management apparatus performs detection of a light source according to the results of analysis or management, so as to determine a relative positions and/or intensity of the light source.

5. The method of claim 4, wherein in step (2), the analysis and management apparatus outputs information related to evaluation of industrial value, information related to profit and loss of business, and/or information related to optimized utilization of light energy according to the results of analysis or management.

6. The method of claim 3, wherein step (2) further comprises:
(2-1) analyzing, evaluating or processing solar energy input data and environmental data related to the solar energy acquired by the detecting apparatus; and
(2-2) installing at least one energy guiding device for the solar energy according to the input data and the environmental data, the energy guiding device being capable of guiding-in, guiding-out, refracting, reflecting, intensifying, dispersing, and collecting the light energy.

7. The method of claim 6, wherein the energy guiding device is a solar energy guiding device, and the solar energy guiding device is adjustable according to an sunlight incident angle so as to track the sun for thereby adjusting and controlling sunlight guided by the solar energy guiding device.

8. The method of claim 4, wherein step (1) further includes:
(1-1) guiding the solar energy by an energy guiding device; and
(1-2) converting the solar energy by a conversion device so as to produce energy or utilize the energy thus produced;
wherein step (2) further comprises: analyzing and managing the input information related to the coordinate positions and the solar energy, and the environmental information by predetermined parameters or rules so as to adjust, maintain or control the energy produced by the conversion device in accordance with the results of analysis or management.

9. The method of claim 8, wherein the conversion device is a temperature-controlling boiler/furnace/kiln or photovoltaic panel or optical and/or utilization device, and another energy is used to increase the temperature of the temperature-controlling boiler/furnace/kiln up to a predetermined value when the energy converted from the solar energy is not sufficient to provide the temperature-controlling boiler/furnace/kiln with the predetermined temperature.

10. The method of claim 9, wherein the energy guiding device is controlled or adjusted to guide in more solar energy, in order to increase the temperature of the temperature-controlling boiler/furnace/kiln to the predetermined value, so if the solar energy is insufficient in amount, another accompanied energy device supplies thermal energy, plasma and/or induction heat source so as to maintain an operating temperature of the temperature-controlling boiler/furnace/kiln.

11. The method of claim 9, wherein, if the energy converted from the solar energy renders the temperature of the temperature-controlling boiler/furnace/kiln higher than the predetermined value, the temperature of the temperature-controlling boiler/furnace/kiln is lowered down to the predetermined value by reducing the temperature of the energy guiding device or abating efficiency of the energy guiding device in guiding-in the solar energy.

12. The method of claim 11, wherein the temperature of the temperature-controlling boiler/furnace/kiln is lowered down to the predetermined value by flow-based gas cooling, increasing contact surface area between thermoelectric material and the temperature-controlling boiler/furnace/kiln to convert heat power into electric power, increasing volume of process materials by adding more materials, or increasing an open surface area of the temperature-controlling boiler/furnace/kiln.

13. The method of claim 8, wherein the environmental information related to input efficiency of the solar energy is sunlight incident angle, distribution of sunlight, weather conditions, air quality, corresponding time, operational status of the energy guiding device, refractive index, or light transmittance.

14. The method of claim 8, wherein in step (2), the energy produced by the conversion device is adjusted, maintained or controlled by turning on/off the energy guiding device, or by adjusting a direction and an angle of the energy guiding device.

15. A system of managing light energy, comprising:
a detecting module for detecting input information related to the light energy and environmental information related to input efficiency of the light energy in real time or at preset time intervals; and
an analysis and management module for analyzing or managing the input information and environmental information via the use of predetermined parameters or rules so as to determine whether to take a corresponding action according to results of analysis or management.

16. The system of claim 15, wherein the analysis and management module evaluates profit and loss of business of a related light energy industry by predetermined real or simulated parameters.

17. The system of claim 15, which is implemented with computer software stored on a storage media.

18. The system of claim 15, wherein the analysis and management module performs detection of a light source according to the results of analysis or management, so as to determine a relative positions of the light source.

19. The system of claim 15, wherein the light energy is solar energy.

20. The system of claim 19, wherein the analysis and management module outputs information related to evaluation of industrial value, information related to profit and loss of business, and/or information related to optimized utilization of light energy according to the results of analysis or management.

21. The system of claim 19, further comprising:
an energy guiding module for guiding the solar energy; and
a conversion module for converting the solar energy guided by the energy guiding module so as to produce energy,
wherein the analysis and management module analyzes or manages the input information related to the solar energy and the environmental information related to the input efficiency of the solar energy via the use of predetermined parameters or rules so as to adjust, maintain or control the energy produced by the conversion module in accordance with the results of analysis or management.

22. The system of claim 21, wherein input data and environmental data related to the solar energy acquired by the detecting module in real time or at preset time intervals are analyzed, evaluated, or processed so as to determine directions, locations and quantity of the energy guiding modules.

23. The system of claim 21, wherein the energy guiding module is a solar energy guiding device, and the solar energy guiding device is adjustable according to a sunlight incident angle, so as to track the sun for thereby adjusting and controlling the sunlight receivable by the solar energy guiding device.

24. The system of claim 21, wherein the energy produced by the conversion module includes electrical energy, thermal energy, and energy of other forms.

25. The system of claim 21, wherein the conversion module is a temperature-controlling boiler/furnace/kiln or photovoltaic panel or optical and/or utilization device.

26. The system of claim 25, wherein another energy is used to increase the temperature of the temperature-controlling boiler/furnace/kiln up to a predetermined value when the energy converted from the solar energy is not sufficient to provide the temperature-controlling boiler/furnace/kiln with the predetermined temperature.

27. The system of claim 25, wherein the solar energy guiding device is controlled or adjusted to guide in more solar energy, in order to increase the temperature of the temperature-controlling boiler/furnace/kiln up to the predetermined value, so if the solar energy is insufficient in amount, another accompanied energy device supplies thermal energy, plasma and/or induction heat source so as to maintain an operating temperature of the temperature-controlling boiler/furnace/kiln.

28. The system of claim 25, wherein, if the energy converted from the solar energy renders the temperature of the temperature-controlling boiler/furnace/kiln higher than the predetermined value, the temperature of the temperature-controlling boiler/furnace/kiln is lowered down to the predetermined value by reducing the temperature of the energy guiding device or abating efficiency of the energy guiding device in guiding-in solar energy.

29. The system of claim 28, wherein the means to lower the temperature of the temperature-controlling boiler/furnace/kiln is lowered down to the predetermined value by flow-based gas cooling, increasing the contact surface area between thermoelectric material and the temperature-controlling boiler/furnace/kiln to convert heat power into electric power, increasing volume of process materials by adding more materials, or increasing an open surface area of the temperature-controlling boiler/furnace/kiln.

30. The system of claim 21, wherein the analysis and management module instructs, according to the information acquired by the detecting module, the energy guiding module to turn on, partially turn on, turn off, and partially turn off, so that the energy produced by the conversion device is adjusted, maintained or controlled.
